(19) United States
(12) Patent Application Publication
(10) Pub. No.: US 2007/0062391 A1
(43) Pub. Date: Mar. 22, 2007

(54) Press unit of a web-fed press

(75) Inventor: Hans-Eckhard Mamberer, Koenigsbrunn (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/516,906

(22) Filed: Sep. 7, 2006

(30) Foreign Application Priority Data
Sep. 10, 2005 (DE) 10 2005 043 082.1

(51) Int. Cl. B41F 13/56

(52) U.S. Cl. 101/225

(57) ABSTRACT

A press unit of a web-fed press is disclosed. The press unit has at least one pair of cylinders including a form cylinder and a transfer cylinder and also an impression cylinder, it being possible for a printing material web to be led through between the transfer cylinder and the impression cylinder and covered with ink. The pair of cylinders has a width of eight horizontal or upright newspaper pages, and the width of the form cylinder has a ratio of 1:3 to 1:5 to the circumference of the form cylinder.

This application claims the priority of German Patent Document No. 10 2005 043 082.1, filed Sep. 10, 2005, the disclosure of which is expressly incorporated by reference herein.

### BACKGROUND AND SUMMARY OF THE INVENTION

The invention relates to a press unit of a web-fed press having at least one pair of cylinders comprising a form cylinder and a transfer cylinder and also an impression cylinder, it being possible for a printing material web to be led through between the at least one transfer cylinder and the at least one impression cylinder and covered with ink.

The printed products of web-fed presses, such as newspapers and printed products similar to newspapers, are printed in different printing formats. Currently, about 30 to 40 different printing formats with a specific page width and page length are known. Many of these formats have a relatively large page width and page length and are therefore felt by the readers to be unwieldy. The trend in the printing sector is therefore towards smaller printing formats, which are printed on the existing press installations in half format or else designated tabloid format. In the case of tabloid format, the printed pages are printed horizontally in relation to the form cylinder, whereas in broadsheet format the printed pages are printed upright.

In Germany, the northern format is known as a typical example for a half or tabloid format, with which for example the newspapers such as “Bild”, “Bild am Sonntag”, “Welt” or “Süddeutscher Zeitung” are printed.

The production of a printed product in half format has the disadvantage, however, that the printed copy cannot be divided up into a plurality of sections, although sectioning of the printed product has the advantage that the finished printed product can be divided up, for example, in accordance with subjects or contents.

German Patent Document DE 198 03 809 A1 from the applicant has already disclosed an offset printing unit at least four pages wide, normally designated 4/2 or 6/2, with which optionally four or more printed pages can be printed in broadsheet or tabloid format.

Furthermore, German Patent Document DE 100 66 162 B4 has disclosed a printing unit six pages wide for a rotary press, in which, by means of an offset arrangement of the clamped ends of three printing blankets located beside one another on the transfer cylinder, low-vibration running of the press is intended to be produced as the transfer cylinders and the form cylinders roll on one another.

It is generally known that widening the press units has a detrimental effect with regard to the oscillatory behavior of the cylinders, which also means that the printing behavior overall is impaired.

On this basis, the inventor has set the following object, specifically of providing an improved press unit for a web-fed press which permits still higher production numbers and in which the known negative oscillatory behavior occurs not at all or virtually not at all.

Hitherto, it has been assumed that the oscillatory behavior of the cylinders in a printing unit of a web-fed press can be influenced positively by reducing the width of the clamping channels for the printing blankets and by means of an offset arrangement of the printing blankets. Accordingly, for printing units six pages wide, approaches to a solution as described in DE 100 66 162 B4 have been followed.

The inventor has recognized that these approaches to a solution influence the oscillatory behavior of the cylinders in a printing unit only to a slight extent. Instead, according to the findings of the inventor, the ratio of the width to the diameter or to the circumferential ratio of the cylinders has an influence on the oscillatory behavior or the tendency to excite oscillations. For example, in the case of double-width press units, which tend to oscillate only to a slight extent, the ratio of the cylinder width to the circumference of the form cylinder is about 1:4. In the case of triple-width press units, which are rather more susceptible to oscillation, this ratio is about 2:1. The lower the ratio of width to diameter or to the circumferential ratio of the cylinders is, the less the cylinders oscillate or the less these can be excited to oscillate.

From the findings obtained, the inventor provides a press unit of a web-fed press having at least one pair of cylinders comprising a form cylinder and a transfer cylinder and also an impression cylinder, it being possible for a printing material web to be led through between the at least one transfer cylinder and the at least one impression cylinder and covered with ink, to the effect that the pair of cylinders has a width of eight horizontal or upright newspaper pages and the width of the form cylinder has a ratio of 1:3 to 1:5 to the circumference of the form cylinder.

By means of the design of a press unit according to the invention, the effectiveness of a web-fed press is increased substantially. For each revolution of the form cylinder, depending on the occupancy of the form cylinder, either 16-page or 32-page products are produced. As compared with this, in the case of double-width or triple-width press units, only 8/16-page or 12/24-page products are possible.

The press unit can be constructed, for example, from four pairs of cylinders and at least one impression cylinder, which are preferably arranged symmetrically or point-symmetrically with respect to the impression cylinder. This may be achieved by means of a 9-cylinder satellite arrangement. In the case of the 9-cylinder satellite arrangement, virtually oscillation-free operation of the web-fed press at all production speeds is made possible. Furthermore, this achieves four-color printing in a simple way.

It is advantageous if a press tower has two 9-cylinder satellite arrangements. The two 9-cylinder satellite arrangements are preferably arranged one above the other. In this way, both sides of the printing material can be provided with four colors in each case in one printing unit.

In order to obtain a manageable format of the finally printed material, it is advantageous if the page length of a newspaper page is approximately between 300 mm and 700 mm. Accordingly, the circumference of the form cylinders and the transfer cylinders is coordinated with this page length.

Furthermore, it is beneficial if the circumference of the at least one form cylinder corresponds to twice the page length of a newspaper page, the circumferential ratio of form cylinder to transfer cylinder having the ratio of 1 to 2.

The width of the printing material should be approximately between 1850 mm and 2300 mm.

In an alternative embodiment, the at least one form cylinder and the at least one transfer cylinder can have bearer rings (Schmitz rings). Oscillation-free running of the cylinders can be ensured in this way.

Alternatively or additionally, the at least one impression cylinder can optionally be designed with or without bearer rings.

A design of the cylinders which is particularly insusceptible to oscillation can be achieved by the cylinders of the pair of cylinders and/or the impression cylinder having a supporting shaft of CRP (carbon fiber-reinforced plastic) and/or GRP (glass fiber-reinforced plastic). In this case, this supporting shaft can extend from one side wall of the printing unit to the other and the cylinder body is shrunk onto this supporting shaft.

This supporting shaft can be formed as a solid axle or as a tube. For example, the design as a tube, in addition to the weight saving as compared with the solid axle, also offers the advantage of a lower moment of inertia. This lower weight or lower moment of inertia has a positive effect on the rotational behavior of the cylinders.

Two printing blankets or an integer multiple number of two printing blankets can be clamped on the transfer cylinder.

### BRIEF DESCRIPTION OF THE DRAWINGS

Preferred developments of the invention emerge from the following description. An exemplary embodiment of the invention, without being restricted hereto, will be explained in more detail by using the drawing, in which:

FIG. 1 shows the basic structure of a press unit having a 9-cylinder system.

### DETAILED DESCRIPTION OF THE DRAWINGS

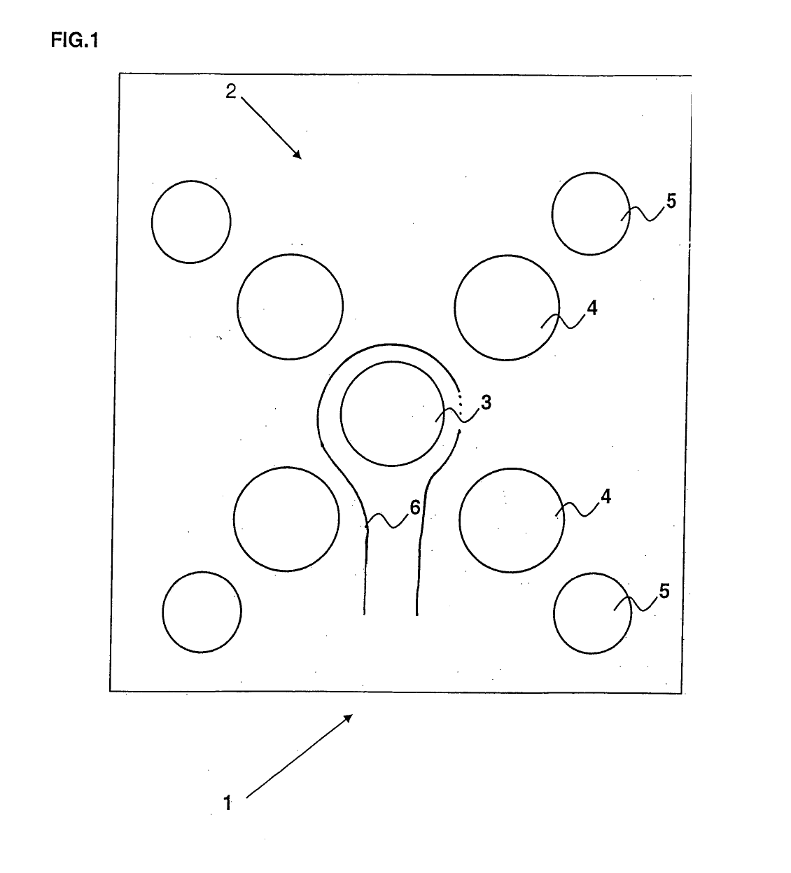

In the following text, the present invention will be described with reference to FIG. 1.

FIG. 1 shows a basic structure of a printing unit 1 which is constructed as a 9-cylinder system 2. This basic structure of the printing unit 1 can also have two 9-cylinder systems 2, which means that during a passage of the printing material web through the printing unit 1, the printing material web 6 can be covered with ink on both sides. In the center of a 9-cylinder system 2 there is the impression cylinder 3. Arranged around this impression cylinder 3 in each case are four transfer cylinders 4, in each case a form cylinder 5 being assigned to each transfer cylinder 4. The adjacent transfer cylinders 4 and form cylinders 5 form a pair of cylinders in each case, which has a cylinder width of eight upright or eight horizontal newspaper pages. The ratio of the width of the form cylinder 5 to the circumference of the form cylinder 5 is between 1:3 and 1:5. Because of the associated positive properties, such as high rigidity and beneficial moment of inertia of the form cylinder 5, such a ratio permits virtually oscillation-free rotation of the form cylinders 5. The circumferential ratio of form cylinder 5 to transfer cylinder 4 is 1 to 2. Ideally, each pair of cylinders 4 and 5 is provided in order to transfer one printing ink.

By means of the invention, a press unit of a web-fed press is provided which, with high production numbers, simultaneously operates with little vibration.

It goes without saying that the features mentioned above and the features of the claims can be used not only in the respectively specified combinations but also in other combinations or on their own without departing from the scope of the invention.

Furthermore, the foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SYMBOLS

1 Printing unit

2 9-cylinder satellite system

3 Impression cylinder

4 Transfer cylinder

5 Form cylinder

6 Printing material web

What is claimed is:

1. A press unit of a web-fed press having a pair of cylinders comprising a form cylinder and a transfer cylinder, and also an impression cylinder, wherein a printing material web is led through between the transfer cylinder and the impression cylinder and covered with an ink, wherein the pair of cylinders has a width of eight horizontal or upright newspaper pages, and wherein the width of the form cylinder has a ratio of 1:3 to 1:5 to a circumference of the form cylinder.

2. The press unit according to claim 1, wherein four pairs of cylinders are included in the press unit and wherein the four pairs of cylinders and the impression cylinder are arranged as a 9-cylinder satellite system.

3. The press unit according to claim 2, further comprising a second four pairs of cylinders and a second impression cylinder and wherein the second four pairs of cylinders and the second impression cylinder are arranged as a second 9-cylinder satellite system.

4. The press unit according to claim 1, wherein a page length of the newspaper page is approximately between 300 mm and 700 mm.

5. The press unit according to claim 1, wherein the circumference of the form cylinder corresponds to twice a page length of the newspaper page.

6. The press unit according to claim 1, wherein a width of the printing material web is approximately between 1850 mm and 2300 mm.

7. The press unit according to claim 1, wherein the form cylinder and the transfer cylinder have a bearer ring.

8. The press unit according to claim 1, wherein the impression cylinder has a bearer ring.

9. The press unit according to claim 1, wherein at least one of the form cylinder or transfer cylinder and/or the impression cylinder includes a supporting shaft of CRP and/or GRP.

10. The press unit according to claim 9, wherein the supporting shaft is formed as a solid axle or as a tube.

11. The press unit according to claim 1, wherein the transfer cylinder has two, or an integral multiple number of two, printing blankets.

12. A press unit of a web-fed press, comprising:
a form cylinder; and
a transfer cylinder, wherein the form cylinder operatively interacts with the transfer cylinder;
wherein a width of the form cylinder has a ratio of between 1:3 to 1:5 to a circumference of the form cylinder.

13. The press unit according to claim 12, wherein a circumferential ratio of the form cylinder to the transfer cylinder is approximately 1:2.

14. The press unit according to claim 12, wherein the form cylinder and the transfer cylinder each have a width of eight newspaper pages.

15. The press unit according to claim 14, wherein a width of the newspaper pages is based on the newspaper pages being disposed either horizontally or upright.

16. The press unit according to claim 15, wherein the horizontally disposed newspaper page is in a tabloid format and wherein the upright disposed newspaper page is in a broadsheet format.

17. A press unit of a web-fed press, comprising:
a first, a second, a third, and a fourth pair of a form cylinder and a transfer cylinder; and
an impression cylinder;
wherein the four pairs of the form cylinder and the transfer cylinder are symmetrically disposed around the impression cylinder such that a 9-cylinder satellite system is formed.

18. The press unit according to claim 17, wherein for each of the four pairs of the form cylinder and the transfer cylinder a width of a respective form cylinder has a ratio of between 1:3 to 1:5 to a circumference of the respective form cylinder.

19. The press unit according to claim 17, wherein for each of the four pairs of the form cylinder and the transfer cylinder a circumferential ratio of a respective form cylinder to a respective transfer cylinder is approximately 1:2.

20. The press unit according to claim 17, wherein for each of the four pairs of the form cylinder and the transfer cylinder the form cylinder and the transfer cylinder each have a width of eight newspaper pages.
